(19) United States
(12) Patent Application Publication
(10) Pub. No.: US 2010/0289648 A1
(43) Pub. Date: Nov. 18, 2010

(54) Wireless Microphone with External Enable

(75) Inventor: Bradley Ree, Cumming, GA (US)

Correspondence Address: Brad Ree, 9020 Montclair Hills Dr, Cumming, GA, 30028, US

(73) Assignee: Bradley Richard Ree, Cumming, GA (US)

(21) Appl. No.: 12/465,611

(22) Filed: May 13, 2009

(51) Int. Cl. G08B 23/00; H04N 7/18

(52) U.S. Cl. 340/573.1; 348/148; 348/E07.085

(57) ABSTRACT

An in-car video system and method is provided where a wireless microphone is configured to detect the removal of an object and enables audio recording. Such actions would be the removal of a gun from a holster. Thus, the wireless microphone would enable the audio recording in the audio/video recorder without the user's intervention. The wireless microphone would also be connected to a health-monitoring sensor, and have the ability to enable the audio recording in the audio/video recorder in a health emergency. The system and method also describes a radio transmitter that would send alerts to a central dispatcher whenever the audio recording is enabled.

### BACKGROUND OF THE INVENTION

The invention is related generally to surveillance systems, and more particularly to a wireless microphone for use with an in-car video system.

Vehicle-mounted surveillance systems have become wide spread in law enforcement. Often these systems are augmented with audio provided by wireless microphones. The microphones are often disabled until the law enforcement office enables the microphone during a time of interest. The current state of the art uses two methods to enable/disable the audio. The simplest method is a switch mounted on the microphone transmitter. This approach has several shortcomings. First, the office may forget to enable the microphone during a time of interest. Second, the officer must use at least one hand to enable the microphone. Third, the office may forget to disable the microphone at the conclusion of the time of interest. Thus, the battery will degrade, or unwanted audio may be recorded.

Another method of enabling the microphone is to have the microphone wait for an enable/disable message to be sent from the video recorder. However, this also has several shortcomings. First, there may be times that the video is recording, but the office may want the audio to be disabled. Second, the audio control is located in the vehicle, while the office may want to enable the audio while located outside the vehicle.

### SUMMARY OF THE INVENTION

A vehicle-mounted surveillance system and method is provided where a wireless microphone is configured in such a way that the audio recording can be enabled from the wireless microphone. The primary difference from the prior art is that the enable is based on the removal of an object from its storage location, such as a gun from a holster. The audio may also be enabled through the detection of physical injuries of the office connected to the wireless microphone.

The preferred embodiment of the invention contains a wireless microphone, a sensor connected to the microphone, and an audio/video recorder located in a vehicle. The wireless microphone transmits an enable message whenever the sensor detects an activation event. The audio/video recorder will receive the enable message and start recording the audio along with the video. The events could be the removal of a weapon from its holster, the removal of handcuffs, or even a weapon being removed from the vehicle. The primary advantage of this method is that the activation of the audio recording does not require the officer to physically touch the wireless microphone. The primary concern of an officer is self-protection through the use of a weapon, and thus the removal of the weapon is a significant event that can justify the recording of the audio from the attached microphone.

In another embodiment, a sensor is capable of monitoring the health of the officer. If a life threatening condition is detected, the audio will be enabled.

In yet another embodiment, a RF transmitter is connected to the audio/video recorder. If the audio is enabled through the removal of a weapon, an alert message is transmitted to the central dispatcher.

### BRIEF DESCRIPTION OF THE DRAWINGS

FIG. 1 is a diagram of the preferred embodiment containing a sensor connected to a wireless microphone, which then communicates to an audio/video recorder;

FIG. 2 is a diagram in which an alert notification transmitter is connected to the audio recorder;

FIG. 3 is a diagram in which the sensor used to enable the audio stream is connected through a RF link with the wireless microphone.

### DETAILED DESCRIPTION

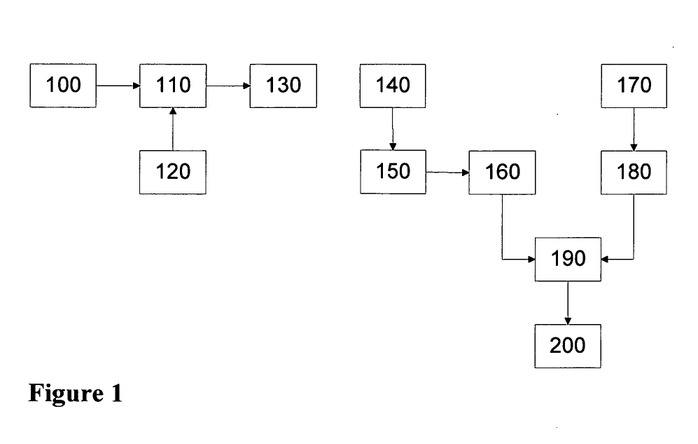

The preferred embodiment is illustrated in FIG. 1. A microphone 100 is connected to a RF transmitter 110. The sensor 120 is also connected to the RF transmitter 110. The RF transmitter 110 is then connected to an antenna 130. These components collectively are referred to as the wireless microphone.

An antenna 140 is connected to a RF receiver 150. The RF receiver 150 is then connected to an audio recorder 160. At least one camera 170 is connected to a video recorder 180. Both the audio recorder 160 and video recorder 180 are connected to a combiner 190. The combined stream is then written into a storage device 200. These components collectively are referred to as the audio/video recorder.

In normal operation, the video recorder 180 is producing a video stream, which is passed through the combiner 190 and into the storage device 200 without any audio present. The sensor 120 has the ability to detect at least one of the following events: removal of a weapon from its holster, removal of handcuffs from its storage container, a loss of blood pressure, a change in heart rate, the sound of a gun shot, a voice prompt. When the sensor 120 detects any of these conditions, an audio enable message is sent through the RF transmitter 110 to the audio/video recorder. The RF receiver 150 receives the enable message and turns on the audio recorder 160. The audio recorder 160 passes the audio stream to the combiner 190, which then produces an audio/video stream. The combined stream is stored in the storage device 200.

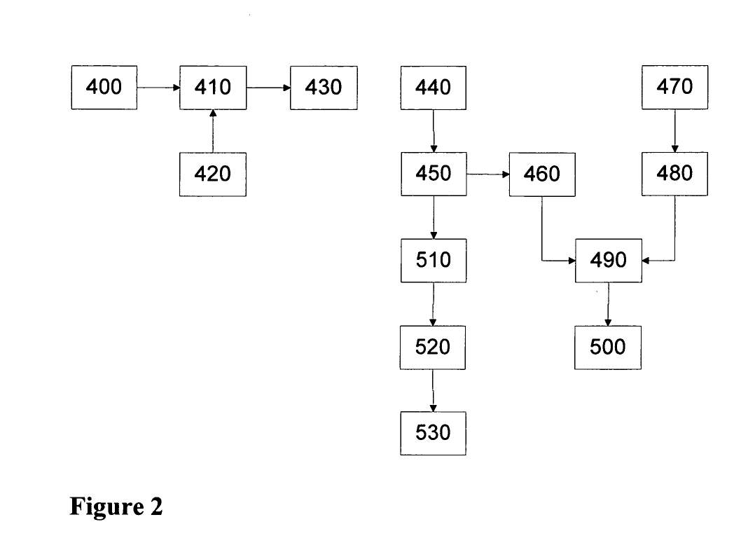

Another embodiment is illustrated in FIG. 2. A microphone 400 is connected to a RF transmitter 410. The sensor 420 is also connected to the RF transmitter 410. The RF transmitter 410 is then connected to an antenna 430. These components collectively are referred to as the wireless microphone.

An antenna 440 is connected to a RF receiver 450. The RF receiver 450 is then connected to an audio recorder 460. At least one camera 470 is connected to a video recorder 480. Both the audio recorder 460 and video recorder 480 are connected to a combiner 490. The combined stream is then written into a storage device 500. An alert generator 510 is connected to the RF receiver 450. The output of the alert generator 510 is connected to a RF transmitter 520. The RF transmitter 520 is then connected to antennae 530. These components collectively are referred to as the audio/video recorder.

In normal operation, the video recorder 480 is producing a video stream, which is passed through the combiner 490 and into the storage device 500 without any audio present. The sensor 420 has the ability to detect at least one of the following events: removal of a weapon from its holster, removal of handcuffs from its storage container, a loss of blood pressure, a change in heart rate, the sound of a gun shot, a voice prompt. When the sensor 420 detects any of these conditions, an audio enable message is sent through the RF transmitter 410 to the audio/video recorder. The RF receiver 450 receives the enable message and turns on the audio recorder 460. The RF receiver 450 also triggers the alert generator 510. The alert generator 510 produces an alert that is passed to the RF transmitter 520, which is connected to the antennae 530. The audio recorder 460 passes the audio stream to the combiner 490, which then produces an audio/video stream. The combined stream is stored in the storage device 500.

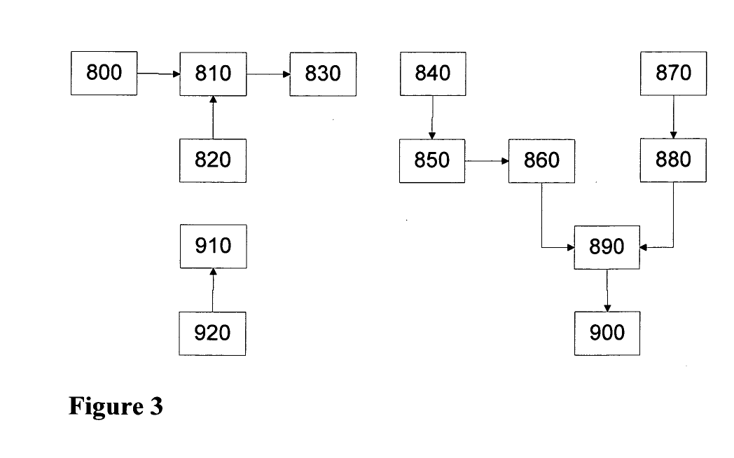

Another embodiment is illustrated in FIG. 3. A microphone 800 is connected to a RF transmitter 810. The RF receiver 820 is also connected to the RF transmitter 810. The RF transmitter 810 is then connected to an antenna 830. These components collectively are referred to as the wireless microphone.

A sensor 920 is connected to a RF transmitter 910. These components collectively are referred to as the wireless sensor. More than one wireless sensor may be present.

An antenna 840 is connected to a RF receiver 850. The RF receiver 850 is then connected to an audio recorder 860. At least one camera 870 is connected to a video recorder 880. Both the audio recorder 860 and video recorder 880 are connected to a combiner 890. The combined stream is then written into a storage device 900. These components collectively are referred to as the audio/video recorder.

In normal operation, the video recorder 880 is producing a video stream, which is passed through the combiner 890 and into the storage device 900 without any audio present. The sensor 920 has the ability to detect at least one of the following events: removal of a weapon from its holster, removal of handcuffs from its storage container, a loss of blood pressure, a change in heart rate, the sound of a gun shot, a voice prompt. When the sensor 920 detects any of these conditions, an enable message is sent through the RF transmitter 910 to the RF receiver 830 located in the wireless microphone. The message is then passed to the RF transmitter 810 and to the audio/video recorder. The RF receiver 850 receives the enable message and turns on the audio recorder 860. The audio recorder 860 passes the audio stream to the combiner 890, which then produces an audio/video stream. The combined stream is stored in the storage device 900.

What is claimed is:

1. A method of operating an in-car video system including a car-mounted camera, video recorder, wireless microphone attached to a user, and an object stored in a storage case. The method comprising the steps of:
a. The wireless microphone detecting the removal of an object from said objects storage case;
b. Said wireless microphone transmitting a message to the video recorder to activate the recording of video from the car-mounted camera, and audio from said wireless microphone;
c. Said wireless microphone transmitting audio to said video recorder.

2. The method of claim 1 wherein said object is a weapon.

3. The method of claim 1 wherein said object is handcuffs.

4. The method of claim 1 wherein said storage case is a holster.

5. The method of claim 1 further including a radio transmitter connected to the video recorder, and the step of transmitting an alert when said video recorder is activated.

6. The method of claim 1 further including the step of recording the removal of said object with said video recorder.

7. A method of operating an in-car video system including a car-mounted camera, video recorder, wireless microphone, and a health-monitoring sensor attached to a user. The method comprising the steps of:
a. The health monitoring sensor detecting an injury of the user;
b. Said health monitoring sensor alerting wireless microphone of said injury;
c. Said wireless microphone transmitting a message to the video recorder to activate the recording of video from the car-mounted camera, and the audio from said wireless microphone;
d. Said wireless microphone transmitting the audio to said video recorder.

8. The method of claim 7 further including a radio transmitter connected to the video recorder, and the step of transmitting an alert when said video recorder is activated.

9. The method of claim 7 further including the step of recording said health-monitoring sensor with said video recorder.

10. A wireless microphone capable of activating an in-car video system that includes a car-mounted camera and video recorder, comprising:
a. An object stored in a storage case;
b. A sensor capable of detecting the removal of said object from said storage case;
c. An input on the wireless microphone capable of receiving a signal from said sensor;
d. A wireless transmitter capable of transmitting an activation command to the video recorder, when said sensor input signal is detected.

11. The object of claim 8 is a weapon.

12. The object of claim 8 is handcuffs.

13. The storage case of claim 8 is a holster.

14. The storage case of claim 8 is a vehicle mounted gun rack.

15. A wireless microphone capable of activating an in-car video system that includes a car-mounted camera and video recorder, comprising:
a. A health monitoring sensor capable of detecting an injury;
b. An input on the wireless microphone capable of receiving a signal from said sensor;
c. A wireless transmitter capable of transmitting an activation command to the video recorder, when said sensor input signal is detected.

16. The wireless microphone of claim 15 whereas the health monitoring sensor is connected to the wireless microphone through an RF link.

17. The wireless microphone of claim 10 whereas the sensor is connected to the wireless microphone through an RF link.
